(19) United States
(12) Patent Application Publication
(10) Pub. No.: US 2002/0096019 A1
(43) Pub. Date: Jul. 25, 2002

(54) Self-ejecting chuck wrench attachment

(76) Inventor: John C. Murray, Broad Top, PA (US)

Correspondence Address: John C. Murray, HC 01 Box 31, Broad Top, PA, 16621-9606, US

(21) Appl. No.: 10/007,938

(22) Filed: Feb. 22, 2002

Related U.S. Application Data
(60) Provisional application No. 60/176,764, filed on Jan. 19, 2000.

(51) Int. Cl. B25B 13/44

(52) U.S. Cl. 81/16

(57) ABSTRACT

One important fact that I do not want to leave out of my summary is that when my Self-Ejecting Chuck Wrench Attachment is used; it is just added to an existing, old fashioned Chuck Wrench that belongs to the customer! In that respect, it takes a very dangerous and potentially “KILLER” tool and immediately turns it into a safe and harmless and utilitarian piece of machinery that never again can do any harm!

There are are only three (3) parts to manufacture. FIGS. No. 1 and 2 and 7. The coiled spring is bought; along with the set screw. The “T” handle and the square tipped main shaft belongs to the customer and never has to leave his manufacturing plant. He does the fitting of the attachment when it arrives from the manufacturer.

The manufacture of my Self-Ejecting Chuck Wrench Attachment in comparison to the cost differential; plus the decided simplicity of my design and never forgetting for an instant that my version is a complete and positive circumvention of a deadly, harmful tool, and turns it into a SAFE tool!

It is a plain and simple fact; that I have come up with an absolutely, new and novel and cheaper; easier and much more practical way of providing the entire Industrial World, with a safe, dependable Self-Ejecting Chuck Wrench! In closing; may I say I have looked over and examined many United States and Foreign Patent documents and references and have found absolutely nothing that my Invention would infringe upon others.

The self-ejecting chuck wrench attachment slips easily over the measured shaft of the chuck wrench and is locked in place with a set screw, thus becoming an integral part of the entire chuck wrench.

To make sure the ejecting mechanism stays in place, the operator, in slipping the self-ejecting device over the squared tip of the wrench sees that the spring-activated plunger is held in place about 1/16th of an inch in back of the squared tip. That placement ensures that the wrench easily finds the square aperture of the chuck jaw. To complete the attachment, the operator removes the whole ejecting device and grinds a small flat at the exact point of where the tip of the set screw will engage it. When this is accomplished, he assembles the ejecting mechanism and locks the set screw.

### EXPLANATION OF ATTACHED DRAWINGS

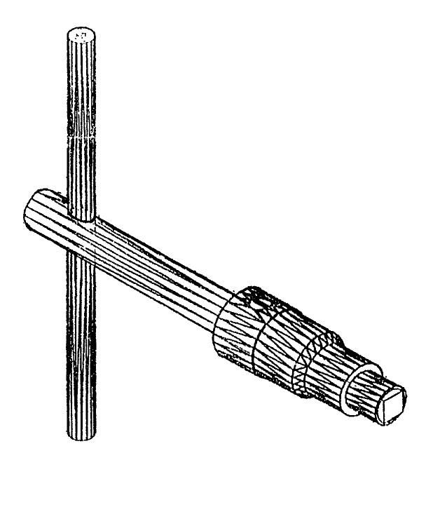

(FIG. 1)—The front ejecting plunger. Positively must be hardened and ground.

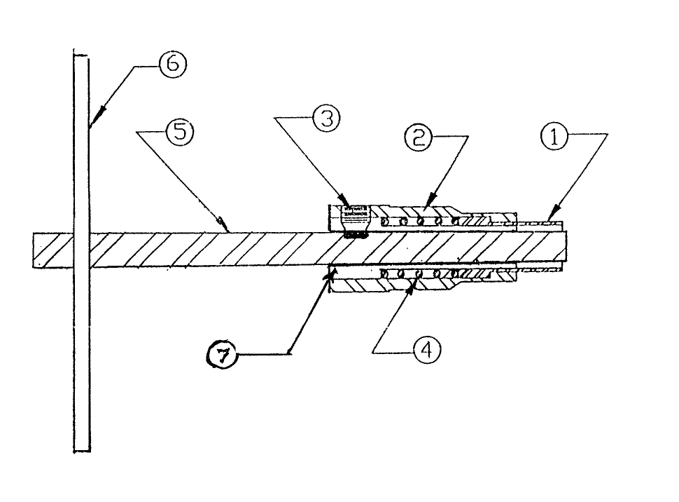

(FIG. 2)—The main frame of the ejecting mechanism. The shoulder towards the front tip determines the stroke of the front plunger. The energy supplied by the compression of the tensile spring that encircles (FIG. 7) which, in turn, encircles the outside diameter of the chuck wrench. At the point where the set screw is located and drilled and tapped through the main frame and the largest diameter of the guide, it leaves a shoulder for the spring to butt against, providing a power base for the compression of the spring. FIG. 5 is the main shaft of the chuck wrench. FIG. 6 is the T handle. FIG. 4 is the toughened, tensile spring that encircles the guide. The set screw is FIG. 3 which when screwed through the main frame of the ejecting mechanism and the guide engages a flat ground into the main frame of the chuck wrench, enabling a positive lock of the ejecting mechanism to the frame of the chuck wrench.

The result of the above—peace of mind in positively knowing that when the operator presses down on the squared tip of the wrench into the matching squares holes of the engine lathe chuck, and the ejecting tip of the wrench contracts and adjusts the work in the machine, and when he knows and is satisfied it is tight and true, he can relax pressure and the wrench self-ejects. No more accidents!

1. My invention relates in particular to a small (2 to 4 inches in length) intricately designed piece of steel that can be quickly attached to any existing chuck wrench. Chuck wrenches, which have been known to be quite deadly and dangerous, have been in use since the Industrial Revolution and have NEVER been improved upon. This type of chuck wrench which is used to adjust, close and lock the piece of work in the rotary chucks of engine lathes and many other types of industrial machines has caused the operator's (and unfortunately many times, innocent bystanders) the most horrible injuries and even death. My attachment dramatically improves upon this piece of machinery and I am certain that using my invention will greatly limit the number of accidents caused each year by machinists using chuck wrenches. The ratio to safe working conditions vs. serious on-the-job injuries will undoubtedly improve!
Using this attachment is simple—the only thing that is required is the outside micrometer measurement of the main shaft of the chuck wrench being fitted. This attachment will fit any of the chuck wrenches in use today throughout the industrial world, from the most elaborate machinists factory to the “weekend warrior” who has a chuck wrench in his garage toolshop. My self-ejecting attachment fits easily over the squared tip of the customer's wrench and is locked in place with a set screw, thus becoming an integral part of the chuck wrench. To make sure the ejecting mechanism stays in place, the operator, in slipping the device over the squared tip of the wrench sees that the spring-operated plunger is held in place about a 1/16^{th} of an inch in back of the squared tip of the wrench (this placement insures that the wrench easily finds the squared aperture of the rotary chuck jaw). To complete the attachment, the operator removes the set screw from the shaft of the wrench and marks exactly where the tip of the wrench engages it. He then grinds a small flat at that point and reassembles and locks the set screw into place. Once he does this, he can be assured—no more accidents or injuries—no more dangerous flying chuck wrenches!
I sincerely hope that some day in the not too distant future, that State and Federal safety laws will be enacted making it mandatory to have all chuck wrenches equipped with my self-ejecting attachment, perhaps even institutions like O.S.H.A. will endorse my invention, clearing the path for a safer work environment across the United States (and perhaps internationally).
One of the main reasons my self-ejecting chuck wrench attachment is superior by far to any other that may be on the market today is the fact that when my attachment is used, it is just “added” to the customer's existing, already in use chuck wrench! In that respect, it takes a very dangerous tool and immediately turns it into an absolutely safe and harmless piece of machinery that can never again cause major accidents in the work area.
The ease of manufacture is obvious. Only three parts to make, only two parts to buy (the set screw and the spring). The “T” handle and the main shaft that is already milled to a square is fitted to the adjusting apertures on the customer's chuck wrench.
The assembly and shipping couldn't be easier. The customer either phones, faxes or sends a written order that contains the micrometer size of the shaft of his wrench and the size of the squared tip. When he receives the attachment in the mail, he does the assembly himself. I am hoping also that the manufacturers of new rotary chuck equipped machines will include my package with their new products being shipped—and will take comfort in knowing that their machines will now SAFELY be used in tool shops and factories and vocational schools across our country.
With the turn of one little screw, a great disadvantage will finally once and for all be taken care of and the safety of the workers in our factories, the safety of the students and instructors in our vocational schools and the safety of our loved ones working on their weekend projects will be once and for all improved upon. My Self-Ejecting Chuck Wrench Attachment can provide this safety to all that use it.
